(19) United States
(12) Patent Application Publication
(10) Pub. No.: US 2016/0364358 A1
(43) Pub. Date: Dec. 15, 2016

(54) UNIVERSAL INPUT DEVICE DRIVER

(71) Applicant: MAD CATZ INTERACTIVE, INC., San Diego, CA (US)

(72) Inventors: Marshall Cai, Shenzhen (CN); Darren Christopher Pursey, Bristol (GB); Daniel Adam Nuth, Bristol (GB); Simon Bell, Herefordshire (GB)

(21) Appl. No.: 14/791,037

(22) Filed: Jul. 2, 2015

(30) Foreign Application Priority Data
Jun. 12, 2015 (CN) 201510323587.4

(51) Int. Cl. G06F 13/42; G06F 13/20

(52) U.S. Cl. CPC G06F 13/42; G06F 13/20

(57) ABSTRACT

Methods, systems, means and machine-readable media embodying program instructions for using a virtual input device to create compatible control signals for a software application using control signals from a remote input device that are incompatible with the software application. Certain methods create a driver that receives first control signals adhering to a first control signal protocol type from an input device connected to a host system. The driver may act as a pass-through for the first control signals, transmitting them to a software-module. Concurrently, the driver may create a virtual input device that appears to the software-module as a device that produces control signals adhering to a second control signal protocol type. The driver may transform the control signals from the first control signal protocol type into the second control signal protocol type before transmitting them to the software-module.

### FIELD

Various embodiments relate to computer systems, and more particularly, to systems, methods and machine-readable media for using a virtual input device to create compatible control signals for a software application using control signals from a remote input device that are incompatible with the software application.

### BACKGROUND

Many modern video games may only be played using game controller peripherals that adhere to a particular input protocol that is compatible with the computer application that controls game play. For instance, some video game titles may only be played using game controllers that adhere to the Human Interface Device (HID) input protocol, and some titles may only be played using controllers that adhere to the XInput protocol (a protocol to which the Xbox 360 controller adheres). This results in a wide range of incompatibility in controlling modern video games for an operator wishing to use a single game controller to play a range of titles.

For instance, if the operator wants to play a particular title on a host system, they need to first know which input protocol that title adheres to, find a video game controller that adheres to that protocol, and then connect the video game controller to the host system. If at some later time they wish to play a different title which adheres to a different input protocol, they must once again know which input protocol that title adheres to, find a video game controller that adheres to that protocol and then connect the video game controller to the host system.

It may also be the case that a new title purchased by the operator cannot be played with a video game controller that the operator currently owns, requiring them to purchase an additional game controller to support the new title.

Previous attempts to address this problem have required the operator to modify configuration files within a video game title's executable directory (the folder that contains a video game title's executable program).

Modifying video game configuration files may require detailed knowledge of the input protocols, and requires some technical ability on the operator's part to not only find, but then modify the correct files in the correct manner. Errors made by the operator could result in the game title becoming unplayable; for instance if while browsing in the game title's executable directory, an operator were to accidentally delete or modify the wrong file.

Clearly, systems and methods that solve the above problems are needed.

### SUMMARY

Certain embodiments of this disclosure relate generally to systems (e.g., networks, devices, or device components), methods and machine-readable media for using a virtual input device to create compatible control signals for a software application using control signals from a remote input device that are incompatible with the software application. Such systems, methods and machine-readable media may receive, from a remote input device, a first control signal that conforms to a first control signal protocol; use the first control signal to create a second control signal that conforms to a second control signal protocol used by a software application; and transmit the second control signal to the software application.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 depicts a host system, wherein one software-module does not support the control signal protocol made available from a driver.

FIG. 2 depicts a host system, wherein a driver receives an incoming signal of a first control signal protocol, transmits that signal to a software module, and creates a virtual input device for outputting a different signal of a second control signal protocol that is based on the incoming signal.

FIG. 3 depicts a host system, wherein a software-module is compatible with multiple control signal protocol types and may accept control signals of a preferred type.

FIG. 4 depicts a host system, wherein a control signal has disabled the creation of a virtual input device.

FIG. 5 depicts a host system, wherein only the control signal created by a virtual input device is made available to the software-module

FIG. 6 depicts a host system, wherein a driver may receive a control signal conforming to one of many control signal protocol types, and transform it into a control signal conforming to a different protocol type.

FIG. 7 depicts a host system, wherein a driver may receive a control signal from any of two or more software-modules, and perform a pass-through or conversion before transmitting the control signal to an input device.

FIG. 8 depicts an embodiment of a driver that creates a virtual input device to receive input from an input device and transmit an output to the software-module.

FIG. 9 illustrates a high-level view of a system topology making use of a virtual input device.

FIG. 10 illustrates a process for creating a virtual input device.

FIG. 11 illustrates a process for transmitting a control signal adhering to Protocol 1 from an input device to a software module that requires control signals adhering to Protocol 2.

FIG. 12 illustrates a process for transmitting a control signal adhering to Protocol 2 from a software module to an input device that requires control signals adhering to Protocol 1.

FIG. 13 illustrates a process for transmitting signals from an input device to a software module.

FIG. 14 illustrates a process for transmitting control signals from a software module to an input device.

Like reference numbers and designations in the drawings indicate like elements.

### DETAILED DESCRIPTION

A driver may be created on a host system that receives first control signals adhering to a first control signal protocol type from an input device connected to a host system. The driver may transmit the first control signals directly or through one or more intermediate drivers to a software-module. Concurrently, the driver may create a virtual input device that appears to the software-module as a device that produces control signals adhering to a second control signal protocol type. The driver may transform the first control signals of the first control signal protocol type into control signals of the second control signal protocol type before transmitting those signals to the software-module.

Likewise, the driver may receive control signals from the software-module that adhere to the first or second control signal protocol types. If the control signals are of the first control signal protocol type, the driver may transmit them to the input device directly or through one or more intermediate drivers. If the control signals are of the second control signal protocol type, the driver may transform them into control signals adhering to the first protocol type before transmitting them to the input device.

Thus, for example, the driver may receive input from any Human Interface Device (HID) peripheral and convert its input data to match the output data of any other protocol. This could be a peripheral connected to a multitude of operating systems (including but not limited to Windows, Mac OSX, Linux, Steam OS, Android, iOS, Fire Fox), running on a multitude of hosts (including but not limited to a PC, smartphone, tablet, game console), via a multitude of connection methods (including but not limited to USB, Bluetooth Classic, Bluetooth Low Energy, Wi-Fi, and Mobile High-Definition Link (MHL) communication protocols).

Attention is now turned to different embodiments described below.

### Example Systems

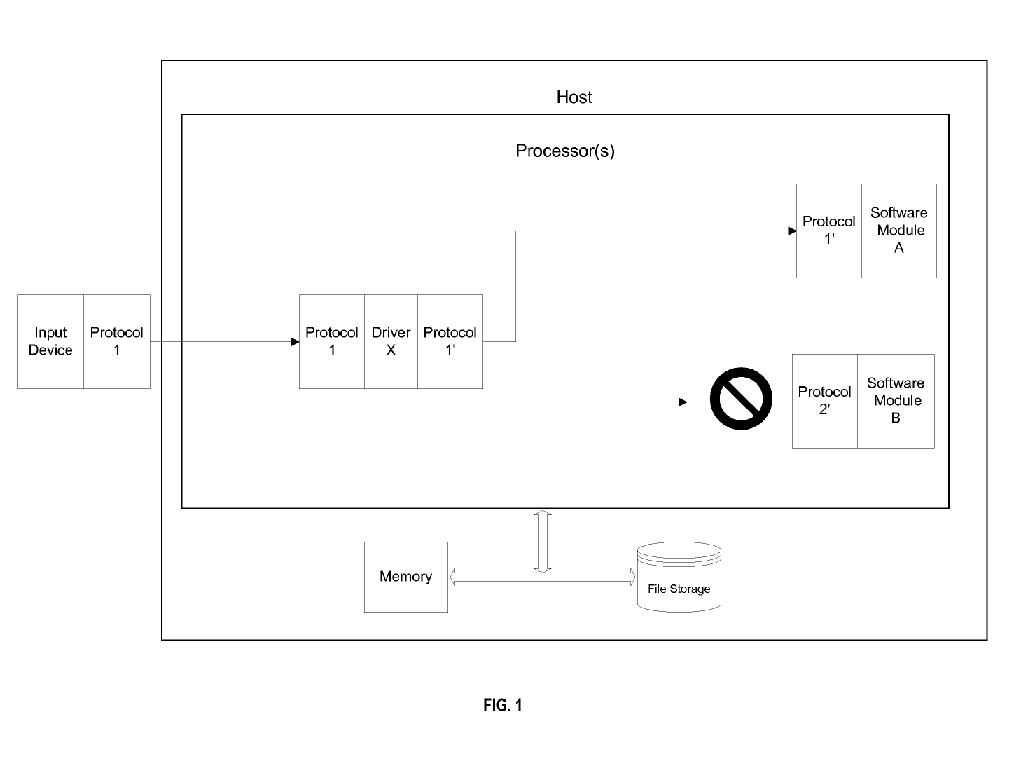

FIG. 1 depicts a host system, wherein one of the software modules (Software Module B) does not support the control signal protocol made available from a driver (Driver X).

In this depiction, an operator connects an input device (e.g. a game controller) that generates and/or receives control signals adhering to a protocol (e.g. HID) that is not supported by the software application that the operator wishes to use (Software Module B).

For instance, Software Module B could be a video game that may only be played using a game controller that adheres to the XInput protocol, but the operator has connected a controller that adheres to another protocol (e.g., the HID protocol). As such, the operator will not be able to control Software Module B with the connected game controller.

The operator at this point can either select a different video game to play that adheres to the HID protocol, or unplug their game controller and plug in a game controller that adheres to the XInput control protocol.

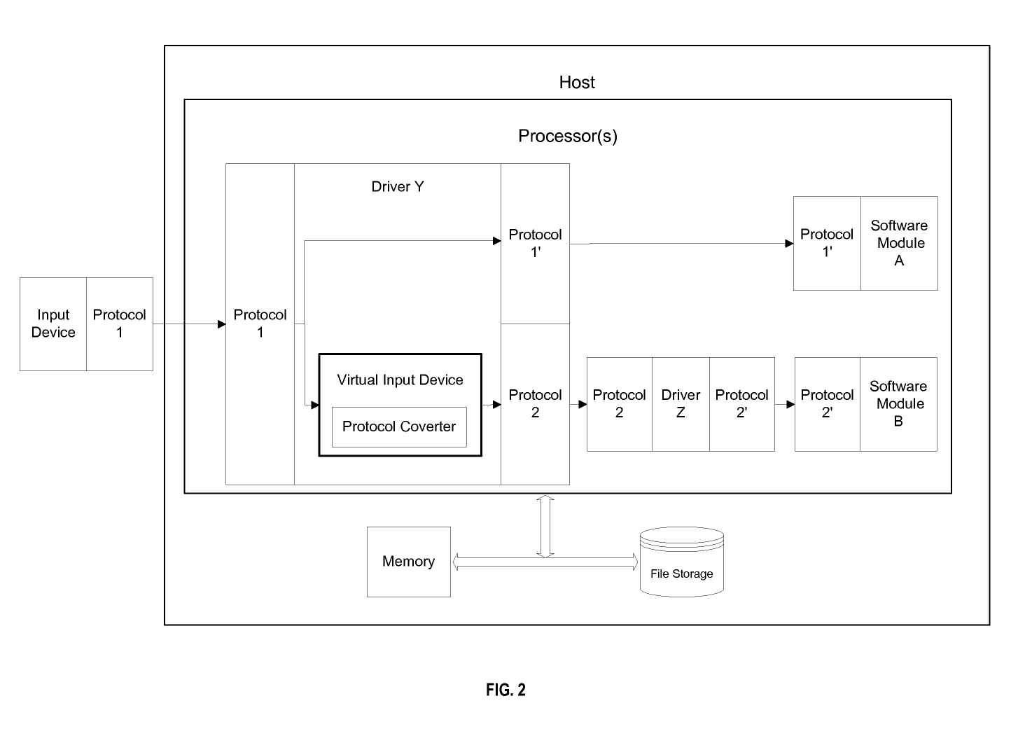

FIG. 2 depicts a host system, wherein a driver (Driver Y) creates a virtual input device to transform control signals adhering to Protocol 1 into control signals adhering to Protocol 2, while the driver concurrently passes through the control signals adhering to Protocol 1 so as to enable a software-module to access to both types of control signal protocols.

For example, if Protocol 1 is HID, Protocol 2 is XInput, Software Module A is a video game that can only be controlled via the HID protocol, and Software Module B is a video game that can only be controlled via the XInput protocol, use of such a driver enables either game to be played using the same input controller. Of course, other types of software modules beyond video games are contemplated, such that intermittent control of the two software modules can be accomplished using only one device.

Under an embodiment of FIG. 2, Driver Z is an intermediate driver which may or may not be enabled on the host system to perform additional transformations or act as a pass-through for the control signals adhering to Protocol 2. For example, Driver Z may be a functional driver providing an interface between the virtual input device and the software-module.

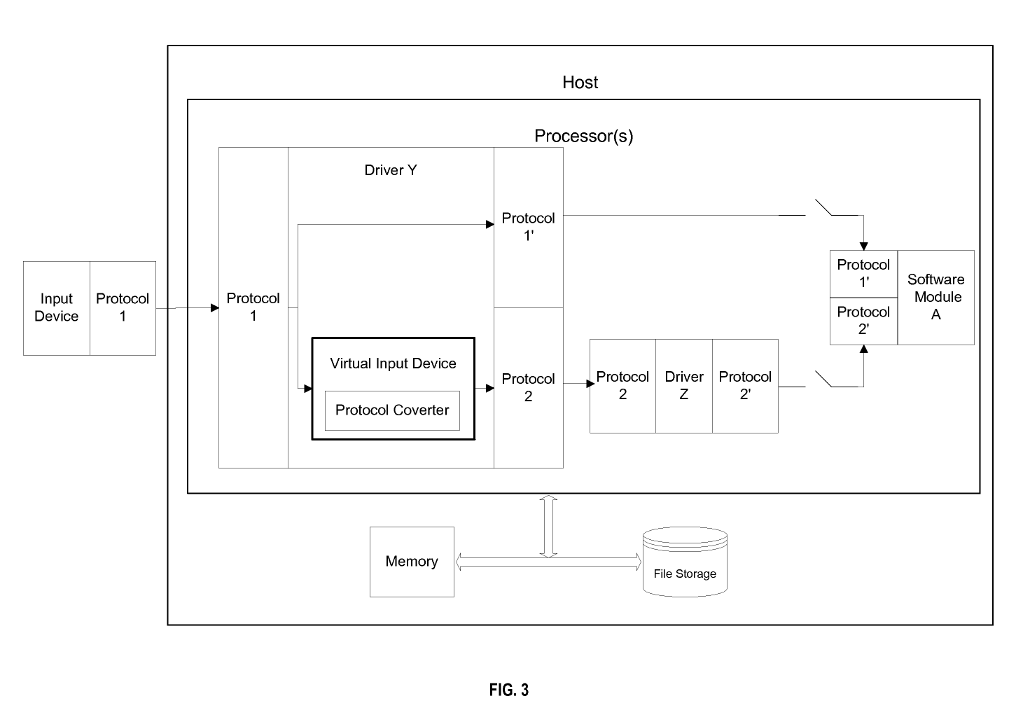

FIG. 3 depicts a host system, wherein a software module is compatible with multiple control signal protocol types, and a control signal of a preferred type may be selected (e.g., by user input, or automatically based on predetermined settings).

For instance, Software Module A may give the operator a choice as to which type of input protocol the operator wishes to use given certain attributes of a particular control signal protocol which may be known to the operator.

For example, an operator playing a video game that can be controlled using either HID or XInput, may select to control the video game with HID, as it may expose more dynamic range than the XInput protocol.

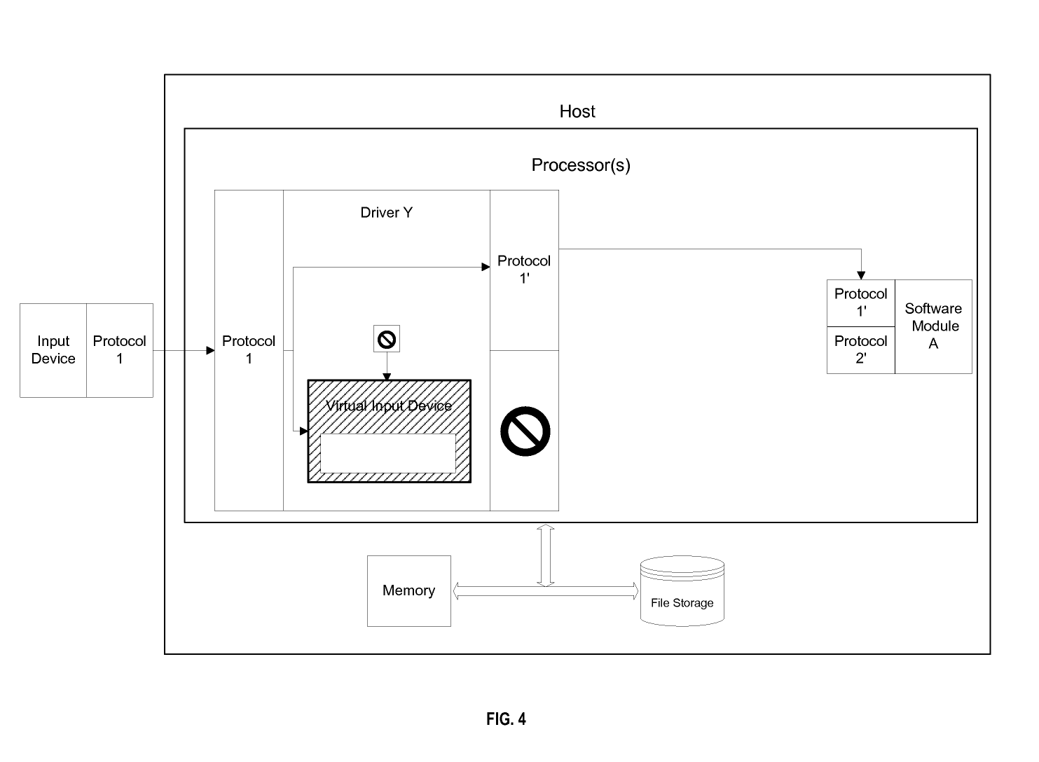

FIG. 4 depicts a host system, wherein a control signal disables the creation of a virtual input device, or disables a previously enabled virtual input device.

In this instance, an operator has indicated to Driver Y that the operator does not want Driver Y to create/use a virtual input device.

The operator may choose to disable the virtual input device if Software Module A can be controlled by control signals adhering to either Protocol 1 or Protocol 2, and the operator wishes to use Protocol 1, but Software Module A does not allow the operator to select a preferred control signal protocol.

In such an instance, disabling the virtual input device will, by de facto, force Software Module A to use control signals adhering to Protocol 1. In one embodiment, enabling the virtual input device will, by de facto, force Software Module A to use control signals adhering to Protocol 2 even though control signals adhering to Protocol 1 are available.

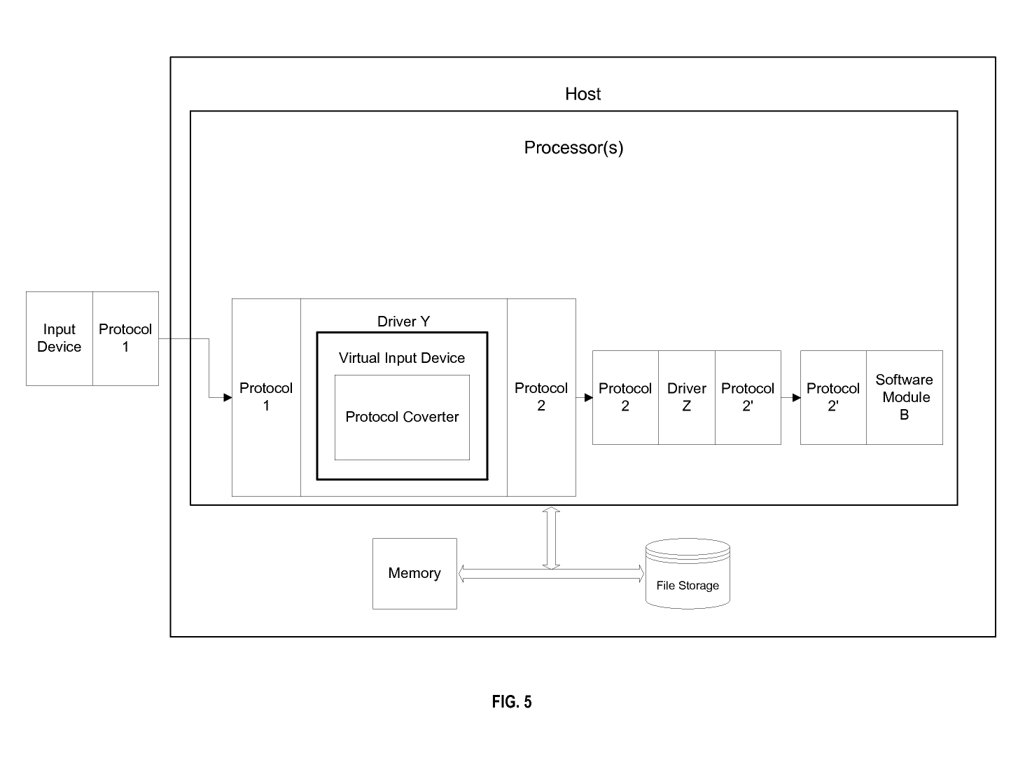

FIG. 5 depicts a host system, wherein only the control signals created by a virtual input device, and not the original control signals, are made available to the software-module.

In this depiction, Driver Y has created a virtual input device and is only outputting control signals adhering to Protocol 2, and is not outputting control signals adhering to Protocol 1.

The operator may choose to disable pass-through of the control signals adhering to Protocol 1 if Software Module B can be controlled by control signals adhering to either Protocol 1 or Protocol 2, and the operator wishes to use Protocol 2, but Software Module B does not allow the operator to select a preferred control signal protocol.

In such an instance, disabling the pass-through of control signals adhering to Protocol 1 will, by de facto, force Software Module B to use control signals adhering to Protocol 2. In one embodiment, enabling the pass-through of control signals adhering to Protocol 1 will, by de facto, force Software Module A to use control signals adhering to Protocol 1 even though control signals adhering to Protocol 2 are available.

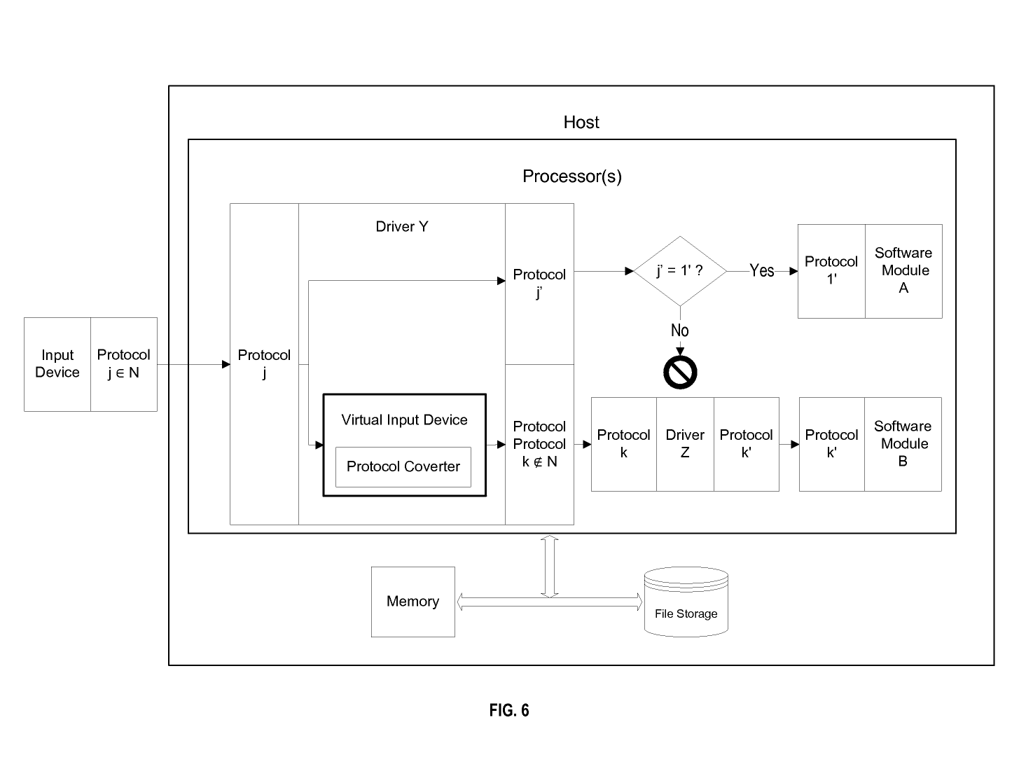

FIG. 6 depicts a host system, wherein a driver may receive a control signal adhering to one of many control signal protocol types and transform the control signal into one of many different control signal protocol types.

For instance, Driver Y may access a list/catalog/database containing a plurality of virtual input devices that can be created, and further containing control signal protocol types for output. Furthermore, such a collection of virtual input devices and control signal protocol types may be updated and modified through different approaches, including but not limited to software/firmware updates, operator input, enablement through operator licensing, and/or updates made via an internet connection. This allows for additional input protocols to be supported as and when they emerge, thus providing an input agnostic solution for a single gaming peripheral.

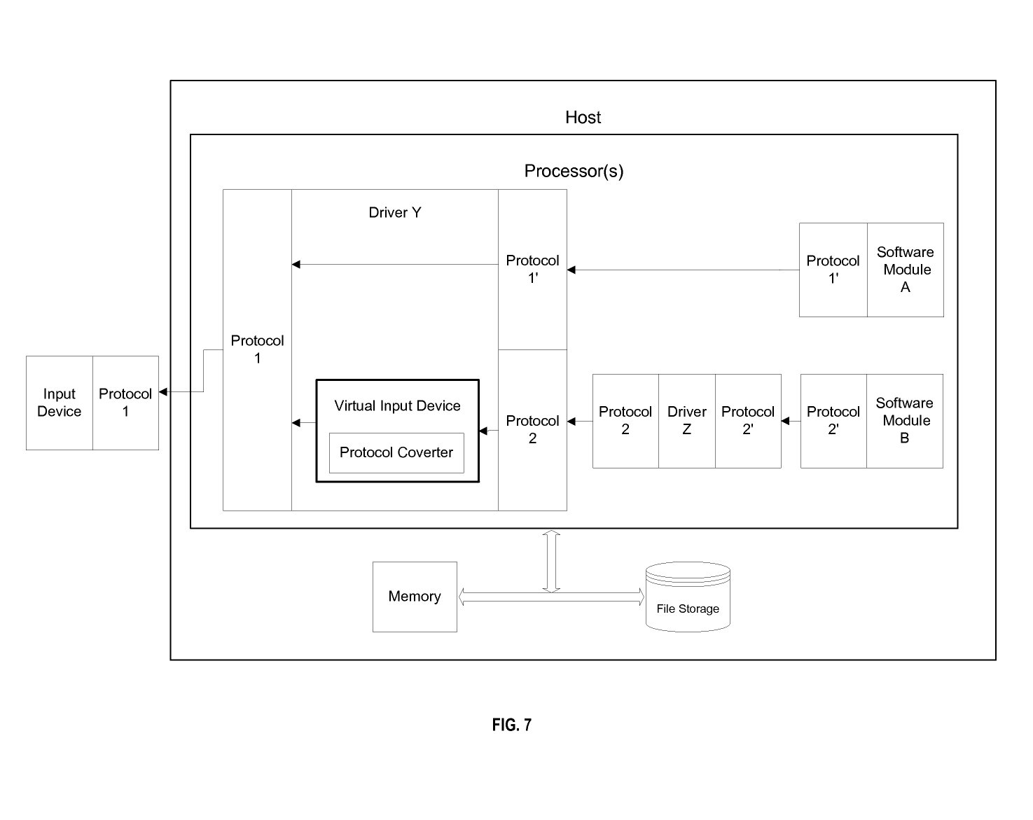

FIG. 7 depicts a host system, wherein a driver may receive control signals of a first or second control signal protocol type from a software module. If the control signal adheres to the first control signal protocol type, the driver may act as a pass-through and transmit the control signal to the input device directly, or through one or more intermediate drivers. If the control signal adheres to a second control signal protocol type, the driver may convert the control signal into the first control signal protocol type before transmitting it to the input device directly, or through one or more intermediate drivers.

For example, a video game controller may generate haptic feedback that is triggered by a change of state in a video game being played. Such control signals originating in the video game, and output from the video game as control signals adhering to the XInput protocol, may be transformed in Driver Y into a control signal supported by the input device being used, if the input device does not support control signals adhering to the XInput protocol.

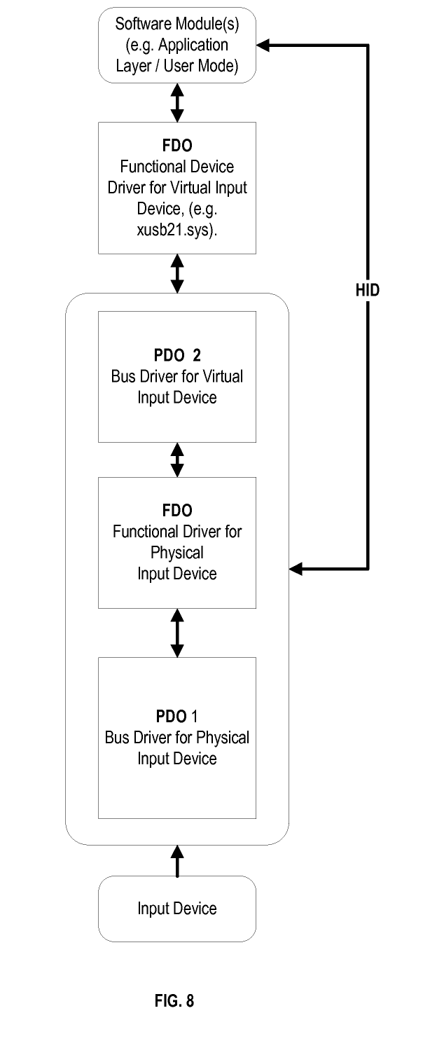

FIG. 8 depicts an embodiment of a driver that creates a virtual input device. This driver may receive control signals from an input device, transform them, and transmit the transformed control signals to a software-module (e.g. an application layer/a user mode).

Within the driver there is a first physical bus driver (PDO 1) that receives control signals of a first protocol type from the input device. Additionally within the driver there is a first functional device driver which receives first control signals of a first protocol type from the physical bus driver and may transform the first control signals and/or concurrently transmit them to the software-module.

Additionally within the driver, is a second bus driver (PDO 2) that implements a virtual enumerated bus into which the first functional device driver may add and remove one or more virtual/emulated devices.

FIG. 8. further shows a second functional driver that the host system has associated with the virtual input device that was, in this example, created by the first functional driver and added to the virtual enumerated bus (PDO 2). This second functional driver may further transform the control signals output from the driver before transmitting them to the software-module.

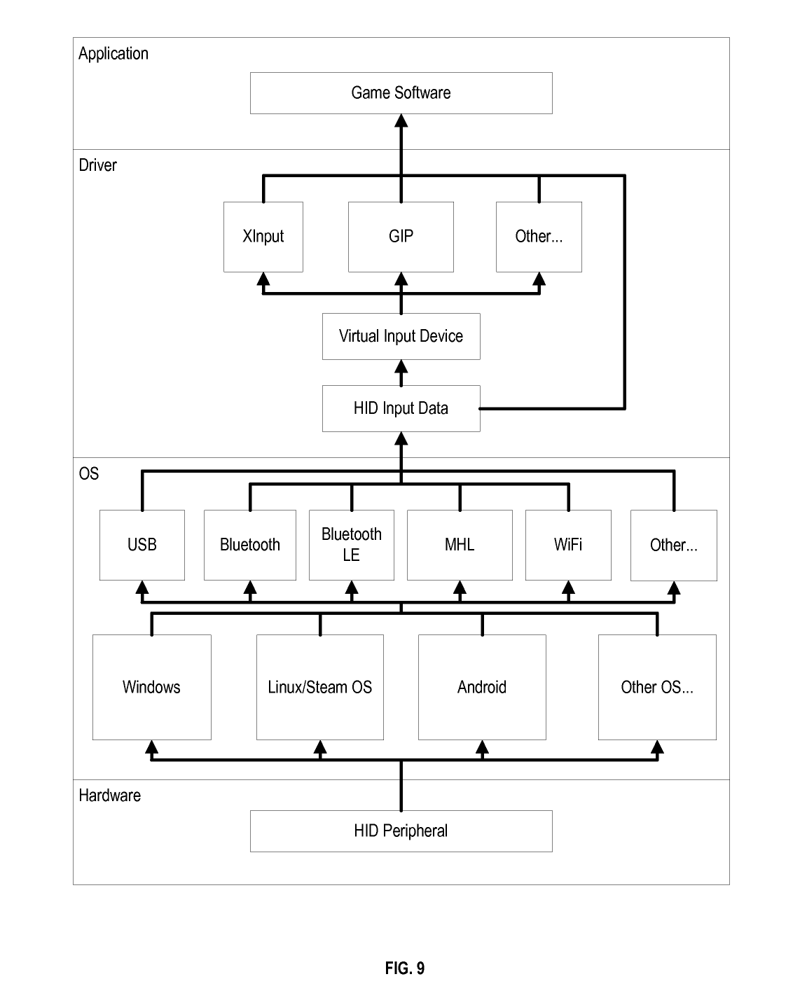

FIG. 9 depicts a high-level view of a system topology making use of a virtual input device.

As shown, an input device such as a game controller adhering to the HID protocol can be connected to a plurality of host systems (including but not limited to Windows, Mac OSX, Linux, Steam OS, Android, iOS, Fire Fox), running on a multitude of hosts (including but not limited to a PC, smartphone, tablet, game console), and communicate to the host system through a plurality of means, including but not limited to USB, Bluetooth Classic, Bluetooth Low Energy, Wi-Fi, and Mobile High-Definition Link (MHL) communication protocols.

The original HID input data is made available to the Application Layer so that any software module adhering to the HID protocol may receive and/or send control signals from/to the input device.

Concurrently, a virtual input device is created so as to perform a transformation of HID protocol signals into control signals adhering to a non-HID protocol, including but not limited to XInput, GIP, and others.

The Driver Layer may create and configure a driver that is associated with the virtual input device and thus allow the Application Layer access to the non-HID control signals created by the virtual device.

### Example Processes

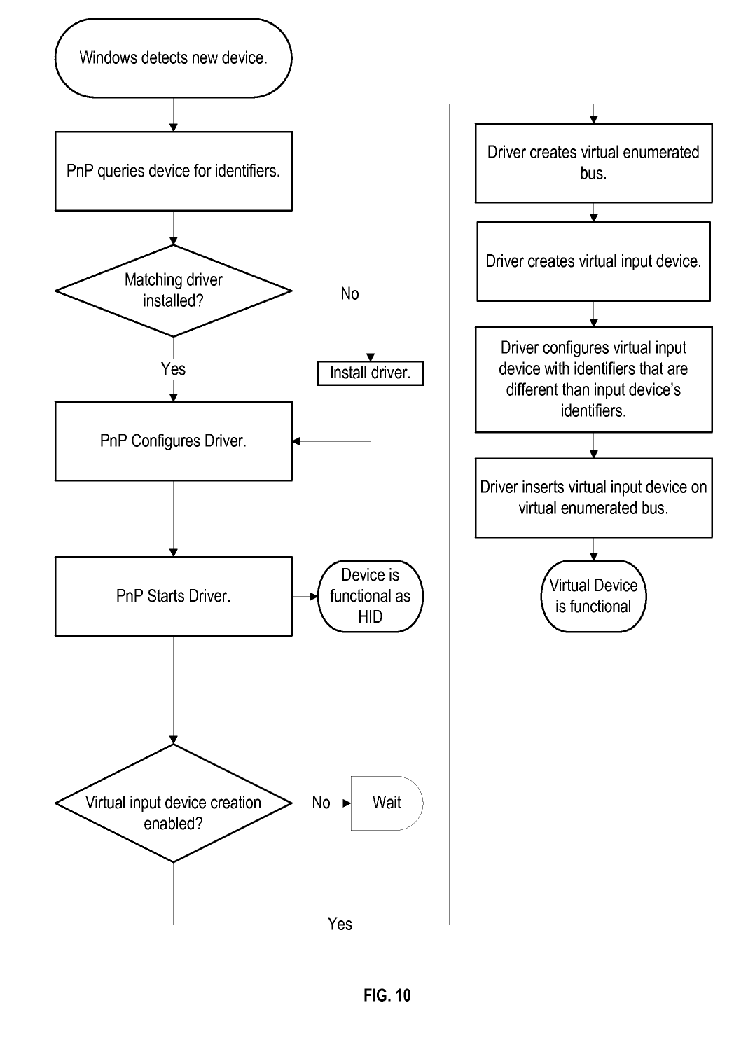

Attention is now drawn to FIG. 10, which illustrates a process for creating a virtual input device while concurrently transmitting control signals adhering to a first control signal protocol type.

As shown, an operator first connects an input device to a host system. Connection could be made via USB, Bluetooth Classic, Bluetooth Low Energy, Wi-Fi, Mobile High-Definition Link communication protocols, or any suitable means of transferring control signals between the input device and the host system. For example, one might connect an input device to the host system through one or more intermediate wired or wireless devices.

Upon recognizing that the connection with an input device has been made, the host system queries the input device for/identification parameters. These parameters may be unique combinations of numerical values or strings that identify the manufacturer of the input device, the model of the device, and/or a plurality of other identifying information.

The host system then determines whether it already has a driver installed for a device having such parameters. If an associated driver is not installed, the host system can initiate an installation procedure that could be completely automatic, or require one or more steps of operator approval, entering or retrieving operator credentials, entering or retrieving proof of licensing, a decision as to which driver to install, and/or identifying the location of the associated driver on the host system, local network, storage media, internet, or the input device itself.

After the existing/newly installed driver has been initialized, it is configured. The configuration stage could include communication between the host system and the input device, as well as loading stored states and/or configuration parameters. The driver is then “started”—e.g. it is made active, at which point it appears to the host system as an interface adhering to control signals of a first protocol type (e.g. HID), and is made available to the software-module for receiving and/or sending control signals from/to the input device.

Under an embodiment, creation of a virtual input device is always enabled, and under another embodiment, the driver may receive a command signal or refer to a previously stored state to determine if creation of a virtual input device has been enabled.

If creation of a virtual input device is enabled, the driver creates a virtual dynamic enumerated bus—e.g. a software implementation that parallels the functionality of a physical dynamic enumerated bus (e.g. USB, PCI), but enables a driver to connect and disconnect virtual/emulated children devices onto the virtual bus.

The driver then creates a virtual input device and configures its identification parameters to correspond to a device that produces control signals adhering to a second control protocol.

For instance, the virtual input device may be configured with manufacturer and device parameters such that it mimics a device that can send and/or receive control signals adhering to the XInput protocol.

The driver then adds the virtual input device (“plugs it in”) to the virtual dynamic enumerated bus. Upon acknowledging that the device has appeared, the host system queries the device for identifiers, just as if the virtual device were physically connected to a physical dynamic enumerated bus. These identifiers may be unique combinations of numerical values or strings that identify the manufacturer of the input device, the model of the device, and/or a plurality of other identifying information.

The host system then determines whether it already has a driver installed for a device having such identifying information. If an associated driver is not installed, the host system can initiate an installation procedure that could be completely automatic, or require one or more steps of operator approval, entering or retrieving operator credentials, entering or retrieving proof of licensing, a decision as to which driver to install, and/or identifying the location of the associated driver on the host system, local network, storage media, internet, or the device itself.

After the existing/newly installed driver has been initialized, it is configured. The driver is then “started”—e.g. it is made active, at which point it appears to the host system as an interface adhering to control signals of the second protocol type (e g XInput), and is made available to the software-module for receiving and/or sending control signals from/to the virtual input device.

Attention is now drawn to FIG. 11, which illustrates a process for transmitting a control signal adhering to a first protocol (Protocol 1) from an input device, to a software module that requires control signals adhering to a second protocol (Protocol 2).

As shown, the driver, having created a virtual input device and having added it to a virtual enumerated bus, may now receive first control signals adhering to Protocol 1 (e.g. HID) from an input device, translate them into second control signals adhering to Protocol 2 (e.g. XInput), and then transmit the second control signals to the software-module that requires control signals adhering to Protocol 2.

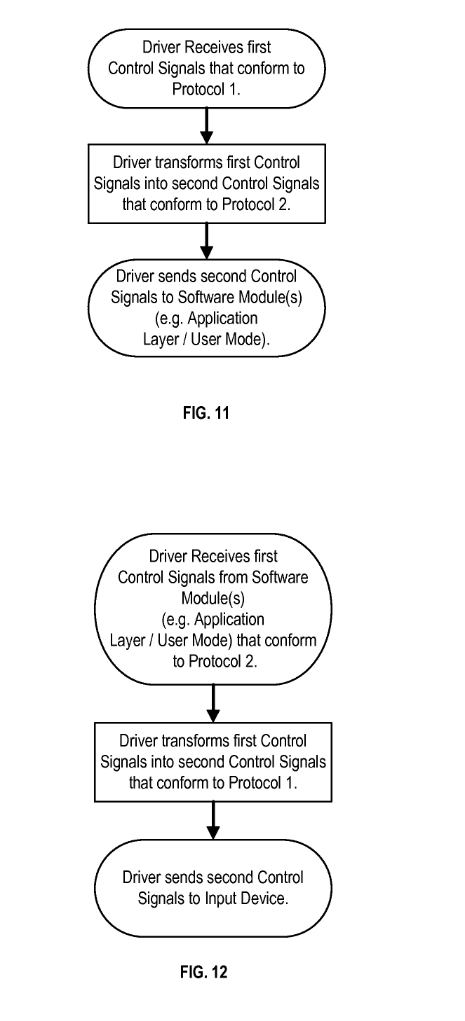

Attention is now drawn to FIG. 12, which illustrates a process for transmitting control signals from a software module to an input device.

As shown, the driver, having created a virtual input device and having added it to a virtual enumerated bus, may now receive first control signals adhering to Protocol 2 (e.g. XInput) from the software-module, translate the first control signals into second control signals adhering to Protocol 1 (e.g. HID), and then transmit the second control signals to an input device that requires control signals adhering to Protocol 1.

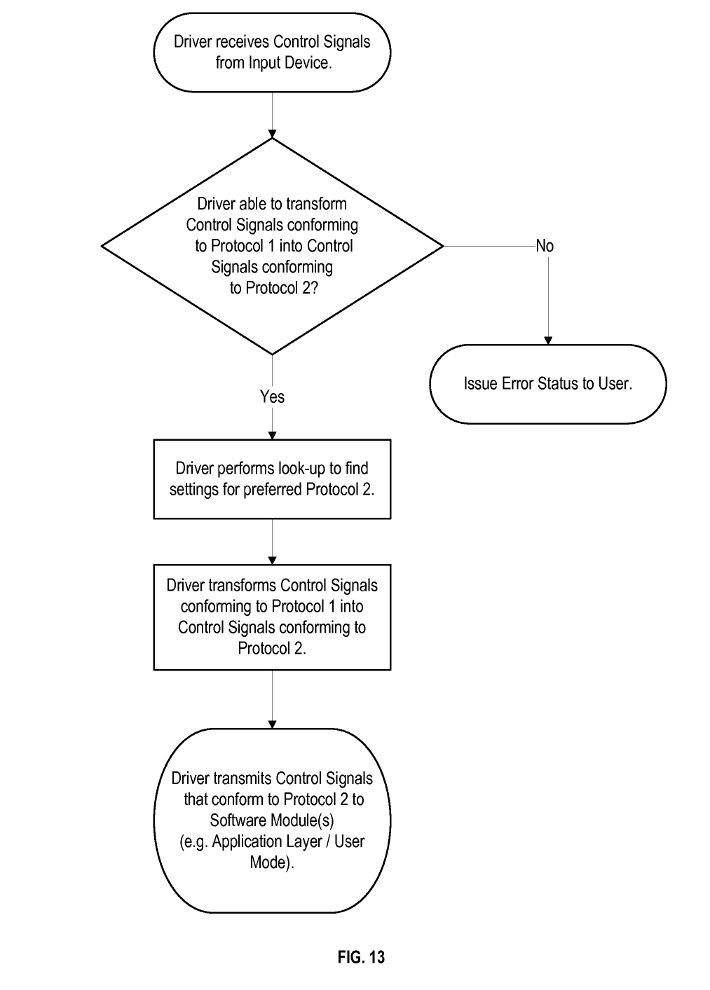

Attention is now drawn to FIG. 13, which illustrates a process for transmitting signals from an input device to a software module.

As shown, the driver in this embodiment receives first control signals which adhere to Protocol 1 from an input device such as a game controller.

The driver then refers to one or more configuration states that were previously saved, or compiled into the driver, to determine if it has the ability to transform the first control signals into second control signals which adhere to a second control signal protocol type. If the driver is not able/enabled to perform the transformation, it may signal a failure or warning state message to the operator.

If the driver is able to convert the first control signals into the second control signals, it may access a data base, configuration file, states stored in volatile or non-volatile memory, a local network, the internet, or a plurality of storage means to determine how to perform the transformation of the first control signals into the second control signals.

Additionally, the driver may look up and make use of separate preferences that pertain to the transformation of control signals, and/or the driver may look up and make use of preferences related to Protocol 2.

The preferences may be stored as a configuration file, as states in volatile or non-volatile memory, on a local network, the internet, or a plurality of storage means. For example, individual, shared, or default preferences for a game title may be stored online and later accessed by an operator or group of operators when playing that game title.

These preferences may contain a table, state machine, or other instructions for performing the transformation of control signals adhering to Protocol 1 into control signals adhering to Protocol 2.

Additionally, such preferences may contain modifications made by the operator to the default protocol transformation.

For example, perhaps the operator prefers that the function normally triggered by a particular button on an input device instead be triggered by a different button on the input device.

Or, perhaps in selecting which virtual input device or devices to load, the driver creates a virtual input device based on the type most recently used by the operator using a stored value in the currently loaded preferences.

After performing the look up of as many preferences that are relevant for a given protocol transformation, the driver then performs the transformation of the first control signals into the second control signals and makes them available to the software-module directly or through one or more intermediate drivers.

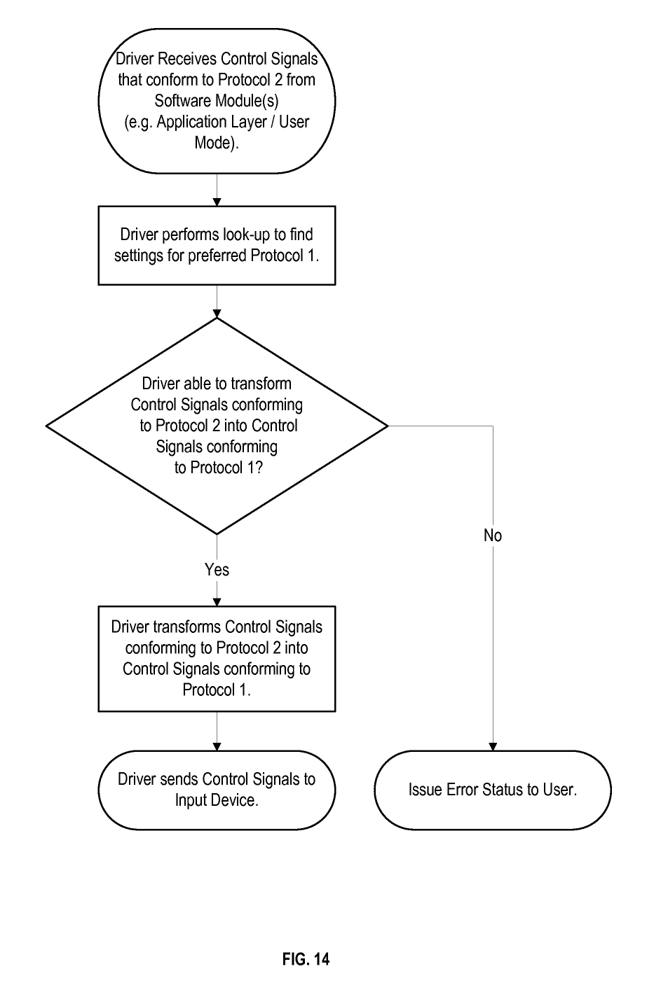

Attention is now drawn to FIG. 14, which illustrates a process for transmitting signals from a software module to an input device.

As shown, the driver receives first control signals which adhere to Protocol 2 from a software module, such as a video game.

The driver then refers to one or more configuration states that were previously saved, or compiled into the driver, to determine if it has the ability to transform the first control signals into second control signals that adhere to a second control signal protocol, Protocol 1. If the driver is not able/enabled to perform the transformation, it may signal a failure or warning state message to the operator.

If the driver is able to convert the first control signals into the second control signals, it may access a database, configuration file, states stored in volatile or non-volatile memory, a local network, the internet, or a plurality of storage means to determine how to perform the transformation of the first control signals into the second control signals. Additionally, the driver may look up and make use of separate preferences that pertain to the transformation, and/or the driver may look up preferences related to Protocol 1.

These preferences may contain a table, state machine, or other instructions for performing the transformation of control signals adhering to Protocol 2 into control signals adhering to Protocol 1.

Additionally, such preferences may contain modifications made by the operator to the default protocol transformation. For example, perhaps the operator prefers that a control signal that normally triggers a game controller to produce a “rumble” haptic feedback effect be disabled so as to disallow haptic feedback. Or, perhaps there are compatibility differences between the type of haptic feedback Protocol 2 provides and what Protocol 1 supports. In this instance, an operator may wish to selectively control which haptic feedback messages are relayed to the input device.

After performing the look up of as many preferences are relevant for a given protocol transformation, the driver then performs the transformation of the first control signals into the second control signals and transmits the second control signals to the input device directly or through one or more intermediate drivers.

### Other Aspects Related to Systems & Methods

Functionality and operation disclosed herein may be embodied as one or more methods implemented, in whole or in part, by machine(s)—e.g., computing component(s), or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more computing components cause the computing components to carry out the method(s).

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency.

By way of example, not by way of limitation, method(s) and computing component(s) or other means may: receive, from a remote input device, a first control signal that conforms to a first control signal protocol; use the first control signal to create a second control signal that conforms to a second control signal protocol used by a software application; and transmit the second control signal to the software application.

Method(s) and computing component(s) or other means may further or alternatively: transmit the first control signal to an additional software application that is compatible with the first control signal protocol.

Method(s) and computing component(s) or other means may further or alternatively: create a virtual input device that is recognized by the software application as an input device that produces control signals conforming to the second control signal protocol.

Method(s) and computing component(s) or other means may further or alternatively: receive, from the input device, an additional control signal that conforms to the first control signal protocol; and receive operator input that disables the virtual input device such that the virtual input device is no longer recognized by the software application as an input device that produces control signals conforming to the second control signal protocol.

Method(s) and computing component(s) or other means may further or alternatively: select the second control signal protocol from among other control signal protocols, wherein the first control signal is used to create the second control signal in response to the selection of the second control signal protocol from among other control signal protocols.

Method(s) and computing component(s) or other means may further or alternatively: select, before the transmitting step, the second control signal instead of the first control signal for transmission to the software application because the second control signal is optimal over the first control signal to control the software application.

Method(s) and computing component(s) or other means may further or alternatively: select the first control signal instead of the second control signal for transmission to an additional software application because the first control signal is optimal over the second control signal to control the software application and transmit the first control signal to the additional software application.

In accordance with some aspects, the second control signals are transmitted to the software application directly or through one or more intermediate drivers.

In accordance with some aspects, the software application is not compatible with the first control signal protocol of the first control signal received from the remote input device.

In accordance with some aspects, the remote input device cannot transmit any control signals that conform to the second control signal protocol.

In accordance with some aspects, the additional software application is not compatible with the second control signal protocol.

In accordance with some aspects, the first control signal protocol conforms to the HID protocol, and the second control signal protocol conforms to the XInput protocol.

In accordance with some aspects, the virtual input device is created automatically by a processor upon detection of the remote input device.

In accordance with some aspects, the virtual input device creates the second control signal, and the second control signal is transmitted from the virtual input device to the software application.

In accordance with some aspects, the second control signal protocol is selected over other control signal protocols because the software application uses the second control signal protocol.

In accordance with some aspects, the second control signal protocol is selected over other control signal protocols because the software does not use the other control signal protocols.

In accordance with some aspects, the first control signal is received using a communication protocol selected from USB, Bluetooth Classic, Bluetooth Low Energy, Wi-Fi, and Mobile High-Definition Link communication protocols.

In accordance with some aspects, the software application is a computer game, and wherein the remote input device is a game controller.

The illustrative methods described herein may be implemented, performed, or otherwise controlled by suitable hardware known or later-developed by one of skill in the art, or by firmware or software executed by processor(s), or any combination of hardware, software and firmware. Software may be downloadable and non-downloadable at a particular system. Such software, once loaded on a machine, changes the operation of that machine.

Systems on which methods described herein are performed may include one or more means that implement those methods. For example, such means may include processor(s) or other hardware that, when executing instructions (e.g., embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g., a processor), such that the machine can read/write information from/to the memory. Memory may be integral with or separate from the machine. Memory may include a non-transitory machine-readable medium having machine-readable program code (e.g., instructions) embodied therein that is adapted to be executed to implement any or all of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

All of the information disclosed herein may be represented by data, and that data may be transmitted over any communication pathway using any protocol, stored on data source(s), and processed by a processor. Transmission of data may be carried out using a variety of wires, cables, radio signals and infrared light beams, and an even greater variety of connectors, plugs and protocols even if not shown or explicitly described. Systems may exchange information with each other using any communication technology. Data, instructions, commands, information, signals, bits, symbols, and chips and the like may be represented by voltages, currents, electromagnetic waves, magnetic fields or particles, or optical fields or particles.

Features in system figures that are illustrated as rectangles may refer to hardware, firmware or software. It is noted that lines linking two such features may be illustrative of data transfer between those features. Such transfer may occur directly between those features or through intermediate features. Where no line connects two features, transfer of data between those features is contemplated unless otherwise stated.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for using a virtual input device to create compatible control signals for a software application using control signals from a remote input device that are incompatible with the software application, the method comprising:
receiving, from a remote input device, a first control signal that conforms to a first control signal protocol;
using the first control signal to create a second control signal that conforms to a second control signal protocol used by a software application; and
transmitting the second control signal to the software application.

2. The method of claim 1, wherein the second control signal is transmitted to the software application directly, or through one or more intermediate drivers.

3. The method of claim 1, wherein the software application is not compatible with the first control signal protocol of the first control signal received from the remote input device.

4. The method of claim 1, wherein the remote input device cannot transmit any control signals that conform to the second control signal protocol.

5. The method of claim 1, the method further comprising:
transmitting the first control signal to an additional software application that is compatible with the first control signal protocol.

6. The method of claim 5, wherein the additional software application is not compatible with the second control signal protocol.

7. The method of claim 1, wherein the first control signal protocol conforms to the HID protocol, and wherein the second control signal protocol conforms to the XInput protocol.

8. The method of claim 1, the method further comprising:
creating a virtual input device that is recognized by the software application as an input device that produces control signals conforming to the second control signal protocol.

9. The method of claim 8, wherein the virtual input device is created automatically by a processor upon detection of the remote input device.

10. The method of claim 8, wherein the virtual input device creates the second control signal, and wherein the second control signal is transmitted from the virtual input device to the software application.

11. The method of claim 8, the method further comprising:
receiving, from the input device, an additional control signal that conforms to the first control signal protocol; and
receiving operator input that disables the virtual input device such that the virtual input device is no longer recognized by the software application as an input device that produces control signals conforming to the second control signal protocol.

12. The method of claim 1, the method further comprising:
selecting the second control signal protocol from among other control signal protocols,
wherein the first control signal is used to create the second control signal in response to the selection of the second control signal protocol from among other control signal protocols.

13. The method of claim 12, wherein the second control signal protocol is selected over other control signal protocols because the software application uses the second control signal protocol.

14. The method of claim 12, wherein the second control signal protocol is selected over other control signal protocols because the software does not use the other control signal protocols.

15. The method of claim 1, the method further comprising:
selecting, before the transmitting step, the second control signal instead of the first control signal for transmission to the software application because the second control signal is optimal over the first control signal to control the software application.

16. The method of claim 1, the method further comprising:
selecting the first control signal instead of the second control signal for transmission to an additional software application because the first control signal is optimal over the second control signal to control the software application; and
transmitting the first control signal to the additional software application.

17. The method of claim 1, wherein the first control signal is received using a communication protocol selected from USB, Bluetooth Classic, Bluetooth Low Energy, Wi-Fi, and Mobile High-Definition Link communication protocols.

18. The method of claim 1, wherein the software application is a computer game, and wherein the remote input device is a game controller.

19. A non-transitory machine-readable medium embodying program instructions adapted to be executed to implement a method for using a virtual input device to create compatible control signals for a software application using control signals from a remote input device that are incompatible with the software application, the method comprising:
receiving, from a remote input device, a first control signal that conforms to a first control signal protocol;
using the first control signal to create a second control signal that conforms to a second control signal protocol used by a software application; and
transmitting the second control signal to the software application.

20. A system for using a virtual input device to create compatible control signals for a software application using control signals from a remote input device that are incompatible with the software application, the system comprising a host computer that:
receives, from a remote input device, a first control signal that conforms to a first control signal protocol;
uses the first control signal to create a second control signal that conforms to a second control signal protocol used by a software application; and
transmits the second control signal to the software application.
